(19) United States
(12) Patent Application Publication
(10) Pub. No.: US 2024/0250720 A1
(43) Pub. Date: Jul. 25, 2024

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventors: Hong SHEN, Nanjing, Jiangsu (CN); Zhikun WU, Beijing (CN); Chen SUN, Beijing (CN)

(73) Assignee: Sony Group Corporation, Tokyo (JP)

(21) Appl. No.: 18/561,317

(22) PCT Filed: May 27, 2022
(86) PCT No.: PCT/CN2022/095532

§ 371 Date: Nov. 16, 2023

(30) Foreign Application Priority Data
Jun. 3, 2021 (CN) 202110619279.1

(51) Int. Cl. H04B 7/04; H04B 7/0456

(52) U.S. Cl. CPC H04B 7/04013; H04B 7/0473

(57) ABSTRACT

An electronic device comprises a processing circuit, which is configured to determine a base-station-side first beam transmitting direction of a base station for a direct link of a user equipment and a base-station-side second beam transmitting direction of the base station for a reflection link of a large intelligent surface (LIS). On the basis of the base-station-side first beam transmitting direction and the base-station-side second beam transmitting direction, the processing circuit determines a first scanning range of the LIS for a reflected beam of a reflection link of the user equipment and a second scanning range of the LIS for a received beam of the user equipment. Additionally, the processing circuit executes control to perform beam training on the reflection link between the LIS and the user equipment on the basis of the first scanning range and the second scanning range.

This application claims priority to Chinese Patent Application No. 202110619279.1, titled “ELECTRONIC DEVICE AND METHOD FOR WIRELESS COMMUNICATION, AND COMPUTER READABLE STORAGE MEDIUM”, filed on Jun. 3, 2021 with the China National Intellectual Property Administration, which is incorporated herein by reference in its entirety.

### FIELD

This application relates to the technical field of wireless communications, and in particular to beam training in wireless communications assisted by a large intelligent surface (LIS). More specifically, the present application relates to an electronic apparatus and a method for wireless communications, and a computer-readable storage medium.

### BACKGROUND

The next generation mobile communication proposes higher requirements in terms of user experience rate, low latency, low power consumption, and other aspects. In order to meet the rapidly growing demand for business traffic and data rate, comprehensive improvement of performance indicators of a communication network has become a key problem confronted by the next generation mobile communication. In order to overcome these challenges, an LIS, implemented by making use of the latest development of metamaterial technology, becomes a promising alternative for enhancing performance of wireless communication systems by using a passive antenna array. The LIS is artificial electromagnetic material composed of a large number of passive reflective elements, and is capable of flexibly controlling a direction of a reflected beam by setting phases of the reflective elements. Therefore, an ideal electromagnetic propagation environment can be obtained with limited power consumption. For example, under the control of a base station, the LIS modifies a phase of an incident wave to obtain a reflected wave in an appropriate reflective direction, so that a signal quality of a receiver is improved. To facilitate understanding, FIG. 1 illustrates a schematic diagram of an auxiliary communication mode based on the LIS.

In LIS-assisted wireless communications, beam training is required to be performed on a direct link between a base station and user equipment and a reflective link between the base station and the user equipment via the LIS, which incurs a significant overhead for training.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus comprises processing circuitry, configured to: determine a first emitting beam direction at a base station side of a direct link of the base station with respect to user equipment, and a second emitting beam direction at the base station side of a reflective link of the base station with respect to an LIS: determine, based on the first emitting beam direction at the base station side and the second emitting beam direction at the base station side, a first scanning range of a reflected beam of a reflective link of the LIS with respect to the user equipment and a second scanning range of a receiving beam of the user equipment: and perform control to perform beam training of the reflective link between the LIS and the user equipment based on the first scanning range and the second scanning range.

According to another aspect of the present disclosure, a method for wireless communications is provided. The method includes: determining a first emitting beam direction at a base station side of a direct link of the base station with respect to user equipment, and a second emitting beam direction at the base station side of a reflective link of the base station with respect to an LIS: determining, based on the first emitting beam direction at the base station side and the second emitting beam direction at the base station side, a first scanning range of a reflected beam of a reflective link of the LIS with respect to the user equipment and a second scanning range of a receiving beam of the user equipment: and performing control to perform beam training of the reflective link between the LIS and the user equipment based on the first scanning range and the second scanning range.

According to an aspect of the present disclosure, an electronic apparatus for wireless communications is provided. The electronic apparatus includes processing circuitry, configured to: receive, from a base station, an identifier of each receiving beam within a particular scanning range, and use the receiving beam to receive a reflected beam from an LIS, wherein the receiving beam and the reflected beam are determined by the base station as being in one-to-one correspondence: determine an optimal receiving beam based on a result of beam measurement: and provide an identifier of the optimal receiving beam to the base station.

According to another aspect of the present disclosure, a method for wireless communications is provided. The method includes: receiving, from a base station, an identifier of each receiving beam within a particular scanning range, and using the receiving beam to receive a reflected beam from an LIS, wherein the receiving beam and the reflected beam are determined by the base station as being in one-to-one correspondence: determining an optimal receiving beam based on a result of beam measurement: and providing an identifier of the optimal receiving beam to the base station.

According to other aspects of the present disclosure, there are further provided computer program codes and computer program products for implementing the methods for wireless communications above, and a computer-readable storage medium having recorded thereon the computer program codes for implementing the methods for wireless communications described above.

With the electronic apparatus and the method according to the embodiments of the present disclosure, a beam scanning range of the reflective link between the LIS and the user equipment is reduced by utilizing the beam emitting direction of the base station relative to the UE and the LIS, thereby reducing an overhead for beam training.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows a schematic diagram of an auxiliary communication mode based on an LIS:

FIG. 2 is a block diagram of functional modules of an electronic apparatus for wireless communications according to an embodiment of the present disclosure;

FIG. 3 shows a schematic diagram of determining a first scanning range and a second scanning range:

FIG. 4 to FIG. 6 show schematic diagrams of a process of determining a first emitting beam direction at the base station side by adopting hierarchical beam training based on a hierarchical codebook:

FIG. 7 to FIG. 9 show schematic diagrams of a process of beam training on a reflective link between a base station and an LIS by adopting hierarchical beam training based on a hierarchical codebook:

FIG. 10 shows a schematic diagram of determining a second emitting beam direction at a base station side:

FIG. 11 shows an example of a beam pair:

FIG. 12 and FIG. 13 show schematic diagrams of a process of determining an optimal reflected beam of an LIS through beam pair scanning:

FIG. 14 to FIG. 18 show schematic diagrams of a process of hierarchical beam training based on a hierarchical codebook:

FIG. 19 shows a block diagram of functional modules of an electronic apparatus for wireless communications according to an embodiment of the present disclosure:

FIG. 20 shows a schematic diagram of information procedure among a base station, an LIS, and UE according to an embodiment of the present disclosure:

FIG. 21 shows a schematic diagram of an example of vertical beam scanning:

FIG. 22 shows a schematic diagram of a first scanning range and a second scanning range:

FIG. 23 shows a schematic diagram of a first scanning range:

FIG. 24 shows a block diagram of functional modules of an electronic apparatus for wireless communications according to another embodiment of the present disclosure:

FIG. 25 shows a flowchart of a method for wireless communications according to an embodiment of the present disclosure:

FIG. 26 shows a flowchart of a method for wireless communications according to another embodiment of the present disclosure:

FIG. 27 is a block diagram showing a first example of an exemplary configuration of an eNB or gNB to which the technology of the present disclosure may be applied:

FIG. 28 is a block diagram showing a second example of an exemplary configuration of an eNB or gNB to which the technology of the present disclosure may be applied:

FIG. 29 is a block diagram showing an example of an exemplary configuration of a smartphone to which the technology according to the present disclosure may be applied:

FIG. 30 is a block diagram showing an example of an exemplary configuration of a car navigation apparatus to which the technology according to the present disclosure may be applied: and

FIG. 31 is a block diagram of an exemplary block diagram illustrating the structure of a general purpose personal computer capable of realizing the method and/or device and/or system according to the embodiments of the present disclosure.

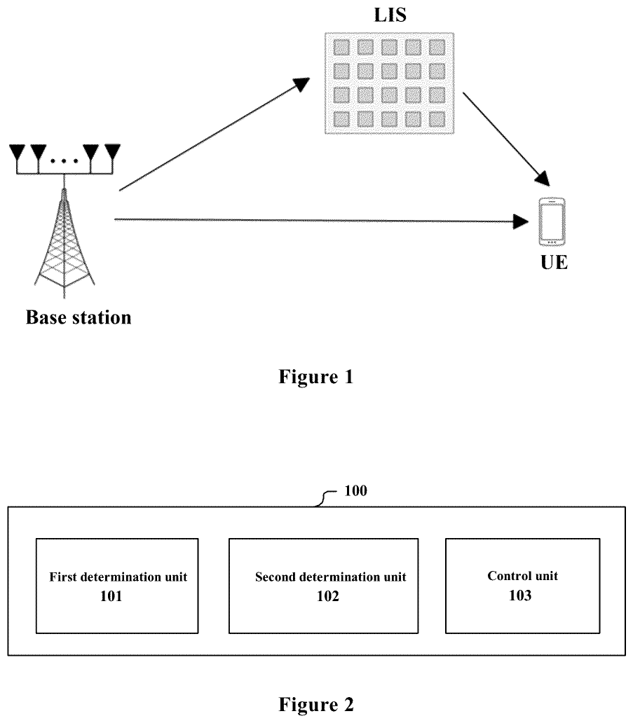

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

An LIS is a passive array and cannot emit any new signals on its own. Therefore, when using the LIS for communication assistance, it is necessary for a base station to assist in beam scanning of the LIS for channel state measurement, so as to perform beam training of a reflective link between the LIS and user equipment (UE). In a case of adopting an exhaustive beam searching method, it is necessary to perform traversal search on all possible emitting beams of the base station, reflected beams of the LIS, and receiving beams of the UE, resulting in a significant overhead for beam training. In view of this, the present disclosure provides a technique that can reduce the overhead for training.

FIG. 2 shows a block diagram of functional modules of an electronic apparatus 100 according to an embodiment of the present disclosure. The electronic apparatus 100 includes a first determination unit 101, a second determination unit 102 and a control unit 103. The determination unit 101 is configured to determine a first emitting beam direction at a base station side of a direct link of the base station with respect to UE, and a second emitting beam direction at the base station side of a reflective link of the base station with respect to an LIS. The second determination unit 102 is configured to determine, based on the first emitting beam direction at the base station side and the second emitting beam direction at the base station side, a first scanning range of a reflected beam of the LIS with respect to the UE and a second scanning range of a receiving beam of the UE. The control unit 103 is configured to perform control to perform beam training of the reflective link between the LIS and the UE based on the first scanning range and the second scanning range.

The first determination unit 101, the second determination unit 102 and the control unit 103 may be implemented by one or more processing circuits. Such processing circuits may be implemented as chips or processors, for example. It should be understood that various functional units in the electronic apparatus shown in FIG. 2 are only logical modules determined based on specific functions thereof, and are not for limiting specific implementation.

The electronic apparatus 100 may be disposed on a base station side or communicatively connected to a base station, for example. The base station described in this disclosure may be a Transmit-Receive Point (TRP) or an Access Point (AP). Here, it should be noted that the electronic apparatus 100 may be implemented at a chip level or may be implemented at a device level. For example, the electronic apparatus 100 may operate as the base station itself and may further include external devices such as a memory and a transceiver (not shown). The memory may store related data information and programs that the base station requires to execute to achieve various functions. The transceiver may include one or more communication interfaces to support communication with different devices (such as UE, other base stations, and the like). An implementation of the transceiver is not specifically limited here.

It should be further noted that in this specification, the terms such as first and second are only for a purpose of distinguishing and do not represent any order or other meaning.

In this embodiment, a beam scanning range (i.e., the first scanning range and the second scanning range) of the reflective link between the LIS and the UE is reduced based on a relative location relationship among the base station, the LIS, and the UE, thereby reducing an overhead for beam training.

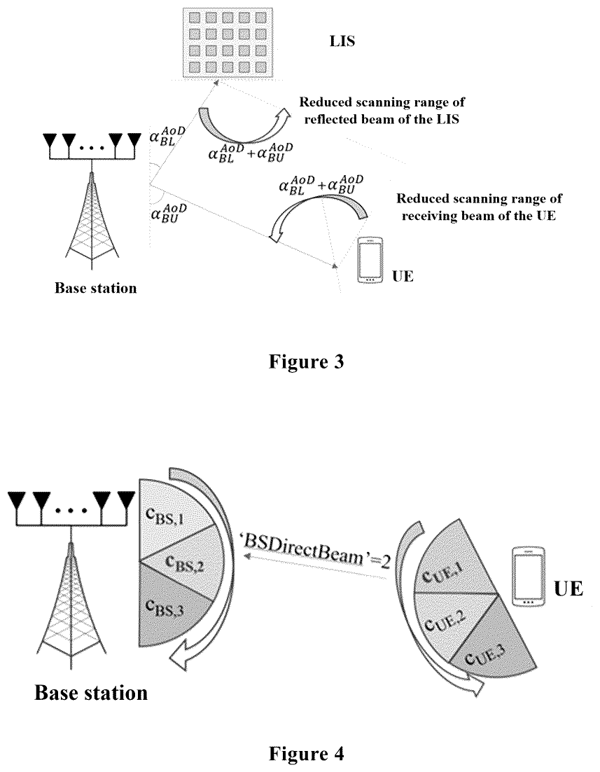

For example, FIG. 3 shows a schematic diagram of determining a first scanning range and a second scanning range. In FIG. 3, α_{BU}^{AoD} represents an angle of departure of a first emitting beam at a base station side, and α_{BL}^{AoD} represent an angle of departure of a second emitting beam at a base station side. The first emitting beam at the base station side, for example, is an emitting beam emitted by the base station to the user equipment whose receiving signal quality meets a first predetermined condition (for example, being above a first predetermined threshold). The second emitting beam at the base station side, for example, is an emitting beam emitted by the base station to the LIS whose receiving signal quality meets a second predetermined condition (for example, being above a second predetermined threshold). For example, the first emitting beam at the base station side may be an optimal emitting beam of the base station with respect to the direct link, and the second emitting beam at the base station side may be an optimal emitting beam of the base station with respect to the reflective link.

As shown in FIG. 3, the second determination unit 102 determines the first scanning range and the second scanning range based on the first emitting beam direction at the base station side and the second emitting beam direction at the base station side, according to a geometric location relationship among the base station, the LIS, and the UE. The first scanning range and the second scanning range each is, for example, a set of opposite angles of a parallelogram constructed by the base station, the LIS, and the UE. Each of the first scanning range and the second scanning range has an angle range as follows: a sum of a first angle of departure (for example, α_{BU}^{AoD} in the figure) corresponding to the first emitting beam direction at the base station side and a second angle of departure (for example, α_{BL}^{AoD} in the figure) corresponding to the second emitting beam direction at the base station side. The LIS and the UE need only to perform beam scanning within the determined first scanning range and the second scanning range. Therefore, the number of reflected beams and receiving beams need to be scanned is reduced and the overhead is decreased.

The first emitting beam direction at the base station side and the second emitting beam direction at the base station side may be determined by the first determination unit 101. In an example, the first determination unit 101 may determine the first emitting beam direction at the base station side by performing beam training on the direct link. For example, the first determination unit 101 determines an optimal emitting beam direction of the base station obtained through beam training as the first emitting beam direction at the base station side.

Methods for beam training may include the aforementioned exhaustive beam searching, which is not specifically described here. In addition, hierarchical beam training based on a hierarchical codebook may also be adopted for determining the optimal emitting beam direction of the base station, where hierarchies of the codebook correspond to different beam widths.

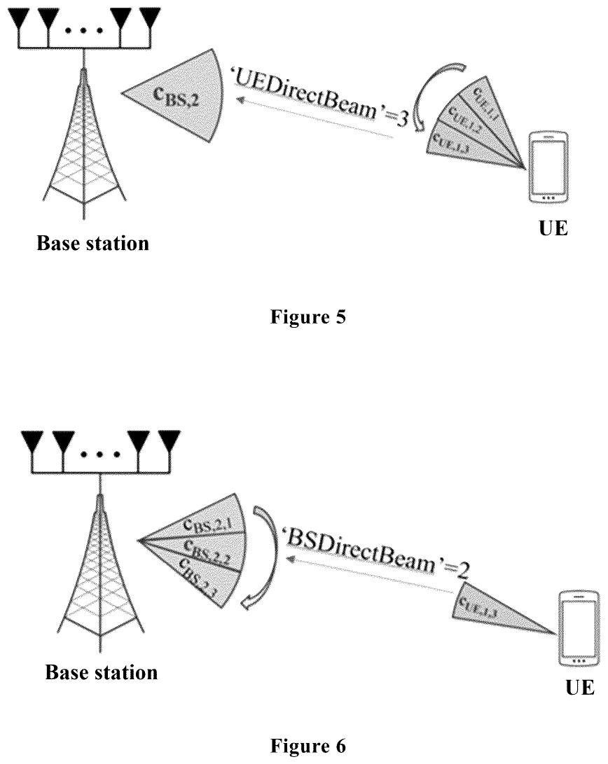

FIG. 4 to FIG. 6 illustrate schematic diagrams of a process of determining the first emitting beam direction at a base station side by adopting hierarchical beam training based on a hierarchical codebook. It should be understood that FIGS. 4 to 6 are only exemplary and not restrictive. As shown in FIG. 4, the base station and the UE first perform wide granularity beam training using a wide beam. The UE measures that an emitting beam C_{BS,2} has an optimal beam quality; and sets BSDirectBeam to the identifier 2 of the beam and sends BSDirectBeam to the base station. As shown in FIG. 5, the base station then uses the wide beam C_{BS,2} for emitting, and the UE uses a narrow beam for reception. The UE measures that the beam quality is optimal when using a receiving beam C_{UE,1,3} for reception, and sets UEDirectBeam to the identifier 3 of the beam and sends UEDirectBeam to the base station. Next, as shown in FIG. 6, the base station uses a narrow beam for emitting and the UE uses the receiving beam C_{UE,1,3} for reception. Finally, the UE measures that a receiving signal for a narrow beam C_{BS,2,2} has an optimal quality, and sets BSDirectBeam to the identifier 2 of the beam and sends BSDirectBeam to the base station. Based on this identifier, the base station determines a direction of the beam C_{BS,2,2} as the first emitting beam direction at the base station side. It can be seen that in this example, the first emitting beam direction at the base station side may be represented by a beam identifier (or referred as a beam index).

Similarly, the first determination unit 101 may determine the second emitting beam direction at the base station side by performing beam training of the reflective link between the base station and the LIS. Method for the beam training may include the aforementioned exhaustive beam searching method or the hierarchical beam training method based on the hierarchical codebook. Since the LIS cannot perform measurement and does not have a transmitter for performing the transmitting operation, the LIS is unable to provide any feedback on information of an emitting beam direction to the base station. However, since the beam used at the LIS is indicated by the base station through the controller, the base station knows the information of both the emitting beam of the base station and the reflected beam of the LIS. Moreover, the base station further knows a sequence number of a time slot occupied by each pair of the emitting beam of the base station and the reflected beam of the LIS. Therefore, in this case, the first determination unit 101 may determine the second emitting beam direction at the base station side based on a serial number of time slot corresponding to a maximum receiving power of the base station. The second emitting beam direction at the base station side may also be represented by a beam identifier (or referred as a beam index).

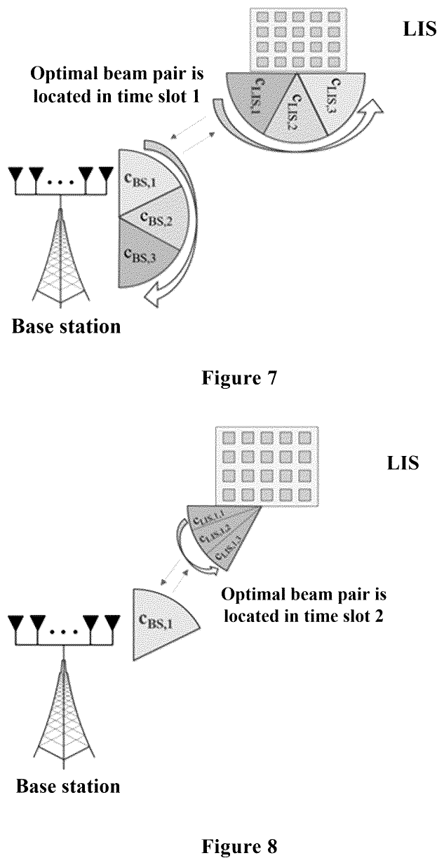

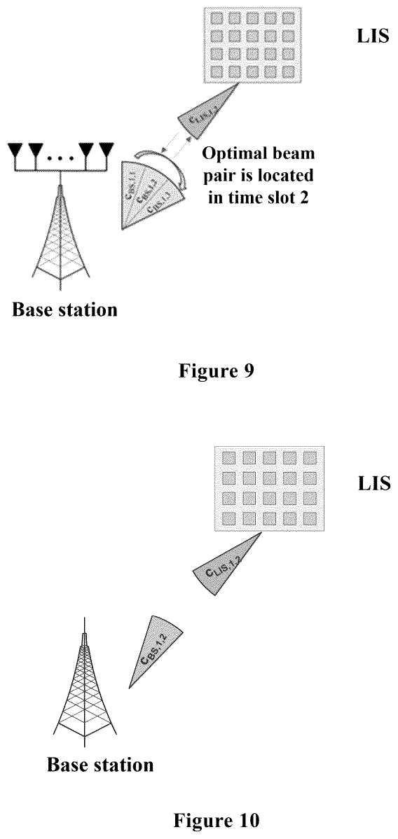

In addition, the hierarchical beam training based on a hierarchical codebook may be adopted for beam training of the reflective link between the base station and the LIS, and an exemplary process is as shown in FIGS. 7 to 9. As shown in FIG. 7, the base station and the LIS first perform wide granularity beam training using a wide beam. The base station measures that a receiving power in time slot 1 is maximum, and thereby determines that the wide emitting beam C_{BS,1} is optimal. As shown in FIG. 8, the base station then uses the wide beam C_{BS,1} for emitting, and the LIS uses a narrow beam for reflection. The base station measures that the receiving power in time slot 1 is maximum at this time, and therefore determines the narrow reflected beam C_{LIS,1,2} of the LIS is optimal. As shown in FIG. 9, next, the base station uses a narrow beam for emitting and the LIS uses C_{LIS,1,2} for reflection. Finally, the base station measures that the receiving power in time slot 2 is maximum at this time, thereby determining that the narrow emitting beam C_{BS,1,2} is optimal, and determines the identifier of the beam as the second emitting beam direction at the base station side.

On the other hand, since the base station and the LIS are positioned in a relatively fixed way, a location of the LIS may be known to the base station. Therefore, the first determination unit 101 may determine the second emitting beam direction at the base station side based on a geometric location relationship between the base station and the LIS, as shown in FIG. 10.

In a case that the first emitting beam direction at the base station side and the second beam direction at the base station side are represented by beam identifiers respectively, each of the first scanning range and the second scanning range includes identifiers of to-be-scanned beams. The identifier may be a serial number or an index, for example.

For example, it is assumed that a serial number of a beam corresponding to the first emitting beam direction at the base station side is n_{UE,max}, and a serial number of a beam corresponding to the second emitting beam direction at the base station side is n_{LIS,min}. Then, a set of serial numbers of beams to be scanned by the LIS is [n_{LIS,min}, n_{LIS,min}+ceil((α_{BL}^{AoD}+α_{BU}^{AoD})/θ_{LIS})], where θ_{LIS} represents an angular resolution of the reflected beam of the LIS, and ceil( ) represents a function to round up to an integer; and a set of serial numbers of beams to be scanned by the terminal is [n_{UE,max}−ceil((α_{BL}^{AoD}+α_{BU}^{AoD})/θ_{UE}), n_{UE,max}], where θ_{UE} represents an angular resolution of the receiving beam of the UE.

The control unit 103 may control the LIS and the UE to perform beam training based on the above mentioned set of serial numbers of beams. For example, the beam training may be an exhaustive beam search within the set of serial numbers of beams, or a hierarchical beam training based on a hierarchical codebook. The hierarchical beam training method here is similar to the hierarchical beam training method described previously with reference to FIGS. 4 to 6, except that the reflected beam direction of the LIS is controlled by the base station through a controller.

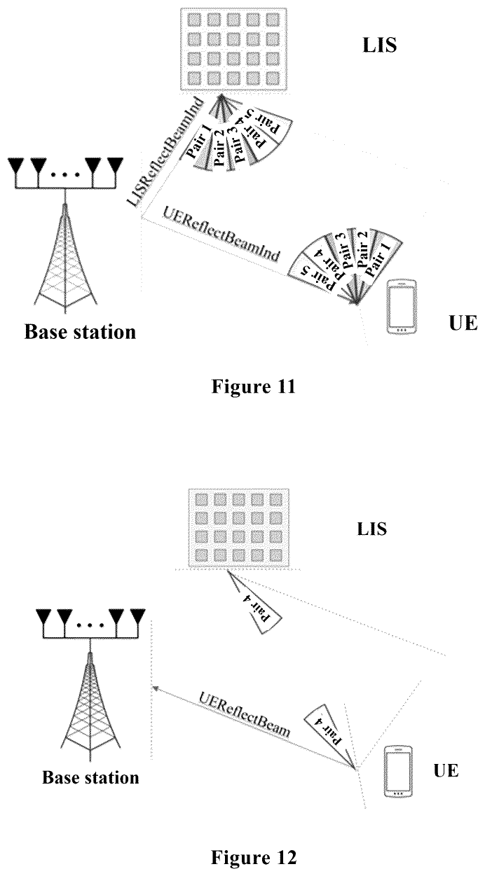

Additionally, in an example, the control unit 103 may further be configured to match a beam within the first scanning range and a beam within the second scanning range as a beam pair in one-to-one correspondence, and control the LIS and the UE to perform beam scanning based on the beam pair. FIG. 11 shows an example of a beam pair. A reflected beam marked with pair 1 and a receiving beam marked with pair 1 forms a beam pair, and the like. In this way, the overhead for beam training can be significantly reduced. In a case that a width of the reflected beam of the LIS is less than a width of the receiving beam of the UE, a m-th serial number pair of beams composed of the serial number of the reflected beam of the LIS and the serial number of the receiving beam of the UE may be represented as:

$$[ {n}_{LIS , m i n} + m , {n}_{UE , ma x} - ceil ( ( {α}_{BL}^{AoD} + {α}_{BU}^{AoD} ) / {θ}_{UE} ) + floor ( m {θ}_{LIS} / {θ}_{UE} ) ]$$

In the representation, floor ( ) represents a function to round down to an integer.

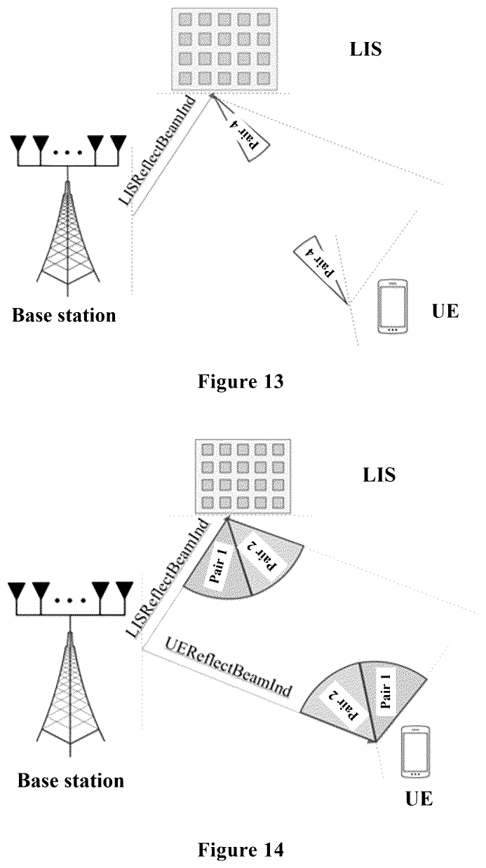

In an example as shown in FIG. 11, there are a total of 5 beam pairs to be scanned. The base station specifies a serial number of a reflected beam and a serial number of a receiving beam of each beam pair to the LIS and the UE through LISReflectBeamInd and UEReflectBeamInd, sequentially. After completing measurement of beam pair 1 to beam pair 5, the UE sets the UEReflectbeam to be a serial number of an optimal receiving beam of the UE and sends the UEReflectbeam to the base station, as shown in FIG. 12. The base station determines a serial number of an optimal reflected beam of the LIS based on the UEReflectbeam and the known sets of beam pairs, and sends the serial number to the LIS controller through the signaling LISReflectBeamInd, so as to control a direction of the reflected beam of the LIS, as shown in FIG. 13.

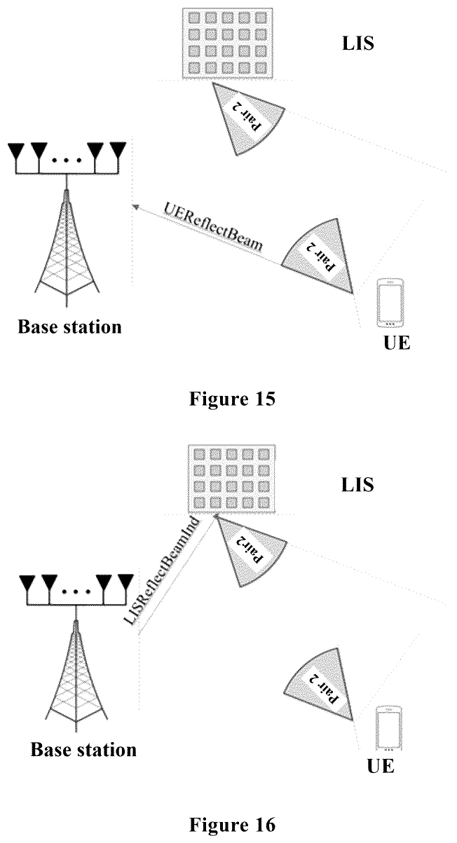

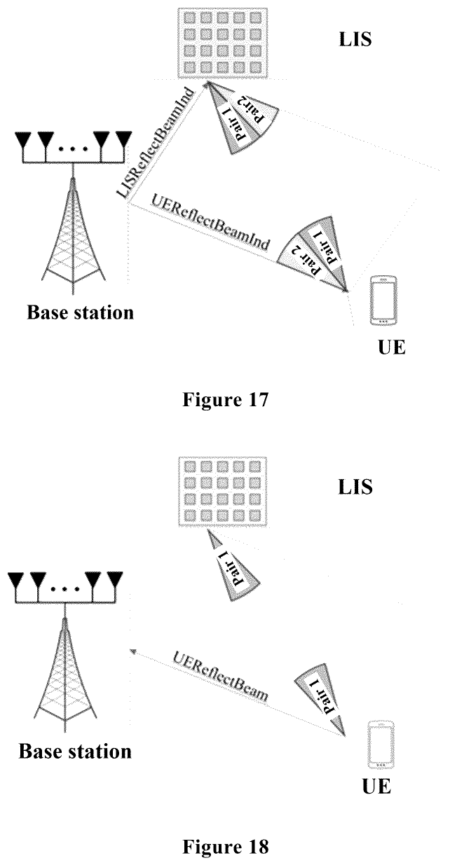

In addition, the beam training may adopt hierarchical beam training based on a hierarchical codebook. FIGS. 14 to 18 illustrate a schematic process of such hierarchical beam training. In the hierarchical beam training, depending on a beam width, there are multiple beam pairs at different hierarchies, such wide beam pairs and narrow beam pairs at two hierarchies to be mentioned below: As shown in FIG. 14, the base station first specifies, based on the wide beam pair, a serial number of a wide reflected beam of the LIS and a serial number of a wide receiving beam of the UE (for example, through LISReflectBeamInd and UEReflectBeamInd, respectively). As shown in FIG. 15, when completing the wide granularity beam training, the UE sets the UEReflectbeam to be a serial number of an optimal wide receiving beam and sends the UEReflectbeam to the base station. As shown in FIG. 16, the base station obtains a serial number of an optimal wide reflected beam of the LIS based on the received UEReflectbeam and the known set of serial number pairs of wide beams, and sends the serial number to the LIS controller through the signaling LISReflectBeamInd. Then, the LIS sets the reflected beam of the LIS based on the signaling. As shown in FIG. 17, scanning of narrow beam pairs is performed based on a result of the scanning of wide beam pairs. After the scanning is completed, the UE sets the UEReflectbeam to be a serial number of an optimal narrow receiving beam of the UE and feeds the UEReflectbeam back to the base station, as shown in FIG. 18. The base station obtains a serial number of an optimal narrow reflected beam of the LIS based on the UEReflectbeam and the known set of serial number pairs of the narrow beams. Next, the base station may send the serial number of the optimal narrow reflected beam of the LIS to the LIS controller through the signaling LISReflectBeamInd, so that the LIS sets its reflected beam based on the signaling. Through such two-hierarchy beam training, the optimal beam pair for the reflective link between the LIS and the UE is found finally. With this method, the overhead for beam training can be further reduced.

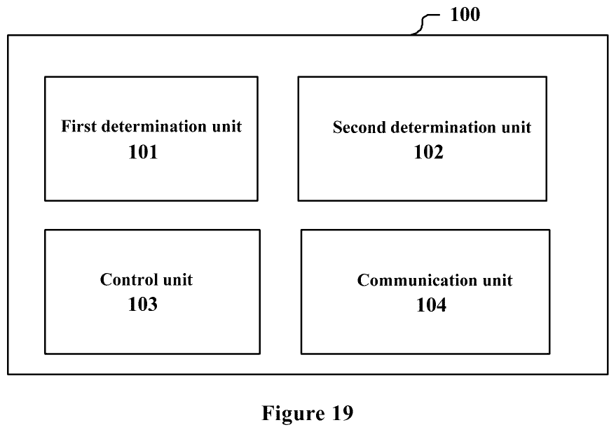

FIG. 19 shows another block diagram of functional modules of the electronic apparatus 100 according to an embodiment of the present disclosure. In addition to the modules shown in FIG. 2, the electronic apparatus 100 further includes a communication unit 104. The communication unit 104 is configured to perform various information interchange with the LIS and the UE.

For example, the communication unit 104 is configured to transmit, to the LIS, a signal indicating an LIS operating mode. The LIS operating mode includes, for example, OFF and ON.

In an example, the communication unit 104 transmits a signaling indicating OFF to the LIS for determining the first emitting beam direction at the base station side, and transmits a signaling indicating ON to the LIS for determining the second emitting beam direction at the base station side and for beam training of the reflective link between the LIS and the UE.

As mentioned above, during the process of performing the beam training for the direct link, the communication unit 104 is further configured to obtain, from the UE, an identifier (such as a serial number) of an optimal emitting beam of the base station with respect to the direct link. The first determination unit 101 determines the first emitting beam direction at the base station side based on the optimal emitting beam of the base station. In addition, the communication unit 104 may further obtain, from the UE, an identifier of an optimal receiving beam of the UE with respect to the direct link.

In another example, the communication unit 104 is further configured to transmit an identifier of a reflected beam within the first scanning range to a controller of the LIS, and transmit an identifier of a receiving beam within the second scanning range to the UE for performing beam scanning. For example, the communication unit 104 may transmit the serial number of the reflected beam in the beam pair as mentioned above to the controller of the LIS, and transmit the serial number of the receiving beam in the beam pair as mentioned above to the UE. The communication unit 104 may perform transmission to the UE through a physical downlink control channel (PDCCH).

Correspondingly, the communication unit 104 is further configured to receive, from the UE, the identifier of the optimal receiving beam for the reflective link determined by the UE through the beam scanning, and determine the optimal reflected beam for the LIS based on the identifier and information of the beam pair. In addition, the communication unit 104 may further receive, from the UE, an identifier of the optimal reflected beam of the LIS with respect to the reflective link determined by the UE through the beam scanning, and the control unit 103 determines the optimal receiving beam of the UE based on the identifier and the information of the beam pair. Alternatively, the communication unit 104 may receive, from the UE, both the identifier of the optimal receiving beam of the UE with respect to the reflective link and the identifier of the optimal reflected beam of the LIS.

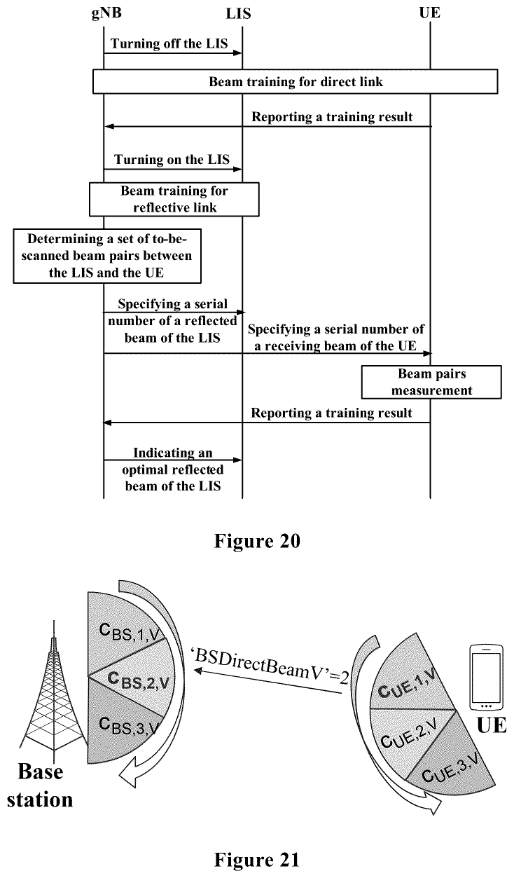

For ease of understanding, FIG. 20 shows a schematic diagram of an information procedure among a base station, an LIS, and UE according to an embodiment of the present disclosure. As shown in FIG. 20, the base station (gNB) first transmits, to the LIS, a signal indicating the LIS to be OFF and the LIS is turned off in response to this signaling. Next, the base station and the UE perform beam training of a direct link, either by adopting the exhaustive beam searching method or the hierarchical beam training method based on a hierarchical codebook. After the beam training is completed, the UE reports a training result to the base station. The training result here may include the identifier of the optimal emitting beam of the base station for the direct link, as well as the identifier of the optimal receiving beam of the UE for the direct link. The base station determines the first emitting beam direction at the base station side based on the training result.

The base station then transmits an instruction to the LIS for turning on the LIS and performs beam training of the reflective link between the base station and the LIS, so as to determine the second emitting beam direction at the base station side. Alternatively, the base station may determine the second emitting beam direction at the base station side based on a geometric location relationship between the base station and the LIS.

The base station determines, based on the determined first emitting beam direction at the base station side and the second emitting beam direction at the base station side, a set of beam pairs to be scanned for the reflective link between the LIS and the UE, for beam training of the reflective link. Based on the set of beam pairs, the base station sequentially specifies, to the LIS, serials numbers of reflected beams of the LIS of the beam pairs, and sequentially specifies, to the UE, serials numbers of receiving beams of the UE of the corresponding beam pairs. The UE performs measurement on the beam pairs and reports a training result to the base station. The training result may include the identifier of the optimal receiving beam of the UE and/or the identifier of the optimal reflected beam of the LIS. The base station indicates, to the LIS, the identifier of the optimal reflected beam of LIS based on the received training result, so that the LIS sets its reflected beam based on this identifier.

Note that the information procedure shown in FIG. 20 is only exemplary but not restrictive.

In summary, with the electronic apparatus 100 according to the embodiment of the present disclosure, a beam scanning range of the reflective link between the LIS and the UE is reduced by utilizing the beam emitting directions of the base station relative to the UE and the LIS, thereby reducing the overhead for beam training.

### Second Embodiment

In a case that an angle of departure of a beam in a vertical direction of the base station and the LIS is adjustable, it is further necessary to perform beam training in the vertical direction. In this case, the first emitting beam direction at the base station side and the second emitting beam direction at the base station side as described in the first embodiment each includes both a horizontal direction and a vertical direction, and the first scanning range and the second scanning range each includes both a horizontal scanning range and a vertical scanning range.

For example, during the beam training of the direct link, it is necessary to perform vertical beam scanning for each horizontal beam pair. FIG. 21 shows a schematic diagram of vertical beam scanning under wide beam training in hierarchical beam training, which is also applicable to the narrow beam training. After the scanning is completed, UE reports, to the base station, an identifier of an optimal vertical emitting beam of the base station, for example, through signaling BSDirectBeamV. In addition, the UE may further report, to the base station, an identifier of an optimal vertical receiving beam of the UE, for example, through signaling UEDirectBeamV.

Similarly, it is also necessary to add operations of vertical beam scanning for each horizontal beam pair for beam training between base stations and the LIS.

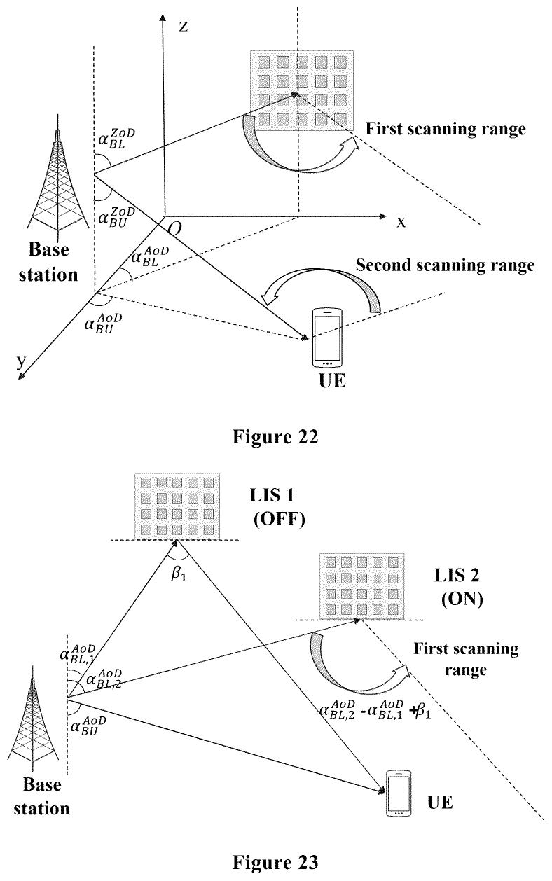

In this case, the first scanning range and the second scanning range determined by the second determining unit 102 are scanning ranges in a three-dimensional space. Therefore, the first scanning range and the second scanning range each includes both a horizontal scanning range and a vertical scanning range. In a case that beam pairs of one-to-one correspondence are determined by the control unit 103, the determined beam pairs are beam pairs in the three-dimensional space. For example, the identifier of the reflected beam and the receiving beam in the beam pair each indicates both a horizontal direction and a vertical direction. FIG. 22 shows a schematic diagram of a first scanning range and a second scanning range in such a case.

The description of the operations and signaling of the electronic apparatus 100 in the first embodiment is also applicable to this embodiment, with a difference only in that the horizontal direction and the vertical direction are distinguished. The operations and signaling are not repeated here.

It can be seen that with the solution of this embodiment, the beam scanning range of the reflective link between the LIS and the UE can be reduced likewise, and the overhead for beam training is reduced.

### Third Embodiment

The above description only shows a case of a single LIS. In this embodiment, a case of there being multiple LISs is described. In the case of there being multiple LISs, the first determination unit 101 determines the second transmitting beam direction at the base station side for each of the LISs sequentially, the second determination unit 102 determines the first scanning range and the second scanning range for each of the LISs sequentially, and the control unit 103 performs beam training of the reflective link between the LIS and the UE for each of the LISs sequentially.

In a case of performing the above mentioned operations with respect to a certain LIS, the communication unit 104 may set the other LISs to an off state through signaling.

In other words, the electronic apparatus 100 in the first and second embodiments may perform the operations for each LIS. Therefore, the descriptions in the first and second embodiments are applicable to the case of multiple LISs and are not repeated here.

In addition, for a latter LIS, the second determination unit 102 may be configured to further reduce the first scanning range and the second scanning range for the latter LIS by utilizing a determination result of the first scanning range and the second emitting beam direction at the base station side for a former LIS. FIG. 23 shows a schematic diagram of a first scanning range in this case, which is also applicable to the second scanning range.

In the example shown in FIG. 23, the beam training for LIS 1 is completed, so α_{BL,1}^{AoD} (the second angle of departure corresponding to the second emitting beam direction at the base station side) and β₁ (half of the first scanning range) are known. Based on the geometric location relationship shown in the figure, a first scanning range for LIS 2 may be obtained as α_{BL,2}^{AoD}−α_{BL,1}^{AoD}+β₁. In a case that the beam training result for LIS 1 is not utilized, the first scanning range for LIS 2 is α_{BL,2}^{AoD}+α_{BU}^{AoD}, which, as can be seen from the figure, is greater than α_{BL,2}^{AoD}−α_{BL,1}^{AoD}+β₁.

In addition, it can be seen that the first scanning range of the LIS 2, α_{BL,2}^{AoD}−α_{BL,1}^{AoD}+β₁, is not related to information of the first emitting beam direction at the base station side of the direct link. Therefore, for an LIS other than the first LIS among the multiple LISs, the second determination unit 102 may determine the first scanning range and the second scanning range without a direct link, and the control unit 103 may perform the beam training of the reflective link without a direct link.

### Fourth Embodiment

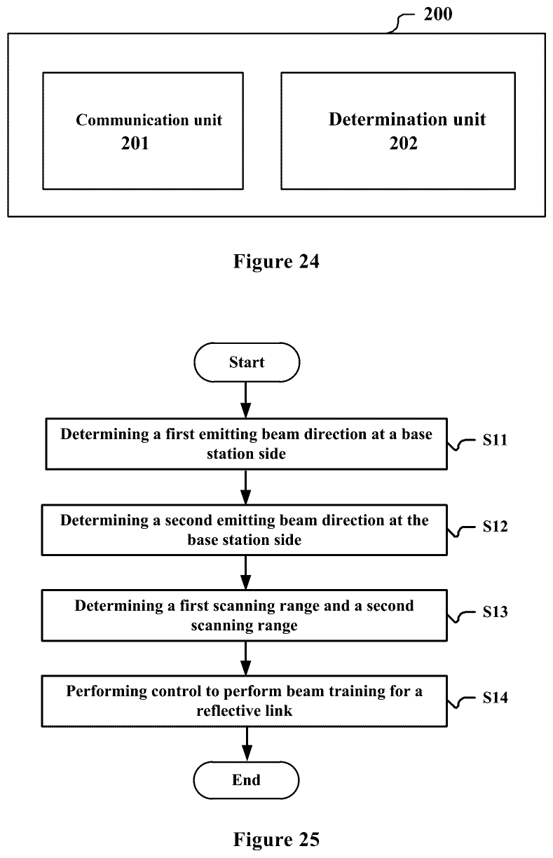

FIG. 24 shows a block diagram of functional modules of an electronic apparatus 200 according to another embodiment of the present disclosure. As shown in FIG. 24, the electronic apparatus 200 includes a communication unit 201 and a determination unit 202. The communication unit 201 is configured to receive, from a base station, an identifier of each receiving beam within a particular scanning range, and use the receiving beam to receive a reflected beam from an LIS, where the receiving beam and the reflected beam are determined by the base station as being in one-to-one correspondence. The determination unit 202 is configured to determine an optimal receiving beam based on a result of beam measurement. The communication unit 201 is further configured to provide an identifier of the optimal receiving beam to the base station.

The communication unit 201 and the determination unit 202 may be implemented by one or more processing circuits. Such processing circuits may be implemented as chips or processors, for example. It should be understood that various functional units in the electronic apparatus shown in FIG. 24 are only logical modules determined based on specific functions thereof, and are not for limiting specific implementation.

The electronic apparatus 200 may be disposed on UE side or communicatively connected to UE, for example. Here, it should be noted that the electronic apparatus 200 may be implemented at a chip level or at a device level. For example, the electronic apparatus 200 may operate as the UE itself and may further include external devices such as a memory and a transceiver (not shown). The memory may store related data information and programs that the base station needs to execute to achieve various functions. The transceiver may include one or more communication interfaces to support communications with different devices (such as base stations, other UE, and the like). An implementation of the transceiver is not specifically limited here.

In this embodiment, the UE performs beam training of the reflective link between the LIS and the UE under a control of the base station. For example, the UE receives, through signaling UEReflectBeamInd, an identifier of a receiving beam indicated by the base station, and reports an identifier of an optimal receiving beam to the base station through signaling UEReflectbeam. In this embodiment, the receiving beam and the reflected beam are in a one-to-one correspondence. For example, as described in the first embodiment, the number of beam pairs to be scanned in beam training is significantly reduced, and the overhead for beam training is reduced. Moreover, since the base station knows the correspondence of the beam pairs, the UE may determine the optimal reflected beam of the LIS based on the correspondence, on receiving the optimal receiving beam reported by the UE.

In addition, the determination unit 202 may be configured to determine an identifier of an optimal reflected beam from LIS, and the communication unit 201 provides the identifier of the optimal reflected beam to the base station. Alternatively, the determination unit 202 determines both the identifier of the optimal receiving beam and the identifier of the optimal reflected beam, and the communication unit 201 provides the two to the base station.

According to this embodiment, the electronic apparatus 200 can determine the optimal beam pair for the reflective link between the LIS and the UE by scanning the beam pairs with one-to-one correspondence under the control of the base station, thereby reducing the overhead for beam training.

### Fifth Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

FIG. 25 shows a flowchart of a method for wireless communications according to an embodiment of the present disclosure. The method includes: determining a first emitting beam direction at a base station side of a direct link of the base station with respect to UE (S11), and determining a second emitting beam direction at the base station side of a reflective link of the base station with respect to an LIS (S12): determining, based on the first emitting beam direction at the base station side and the second emitting beam direction at the base station side, a first scanning range of a reflected beam of the LIS with respect to the UE and a second scanning range of a receiving beam of the UE (S13): and performing control to perform beam training of the reflective link between the LIS and the UE based on the first scanning range and the second scanning range (S14). This method may be performed on a base station side, for example.

In step S11, the first transmitting beam direction at the base station side may be determined by performing beam training on the direct link. For example, hierarchical beam training based on a hierarchical codebook may be adopted to determine the first emitting beam direction at the base station side.

In step S12, the second emitting beam direction at the base station side may be determined by adopting one of the following manners: performing beam training on the reflective link between the base station and the LIS: determining based on a geometrical location relationship between the base station and the LIS. Performing beam training on the reflective link between the base station and the LIS may include adopting hierarchical beam training which is based on a hierarchical codebook. In a case of determining the second transmitting beam direction at the base station side by performing beam training on the reflective link between the base station and the LIS, the second emitting beam direction at the base station side may be determined based on a serial number of a time slot corresponding to a maximum receiving power of the base station.

In step S13, the first scanning range and the second scanning range may be determined based on the first emitting beam direction at the base station side and the second emitting beam direction at the base station side, according to a geometrical location relationship among the base station, the LIS and the UE. For example, the first scanning range and the second scanning range may both have an angle range as follows: a sum of a first angle of departure corresponding to the first emitting beam direction at the base station side and a second angle of departure corresponding to the second emitting beam direction at the base station side. For example, the first emitting beam direction at the base station side and the second emitting beam direction at the base station side are represented by beam identifiers, respectively. Each of the first scanning range and the second scanning range includes identifiers of to-be-scanned beams.

In an example, in step S14, a beam within the first scanning range and a beam within the second scanning range are matched as a beam pair in one-to-one correspondence, and the LIS and the UE are controlled to perform beam scanning based on the beam pair.

In addition, the beam training of the reflective link between the LIS and the UE may be performed by adopting hierarchical beam training based on a hierarchical codebook.

Although not shown in FIG. 25, the method may further include transmitting, to the LIS, a signaling indicating an LIS operating mode which includes OFF and ON. For example, a signal indicating OFF may be transmitted to the LIS before step S11 for determining the first emitting beam direction at the base station side, and then a signal indicating ON may be transmitted to the LIS for determining the second emitting beam direction at the base station side and performing the beam training of the reflective link between the LIS and the UE.

In addition, the method may further include obtaining, from the UE, an identifier of an optimal emitting beam of the base station with respect to the direct link, and determining the first emitting beam direction at the base station side based on the optimal emitting beam of the base station. An identifier of an optimal receiving beam of the UE with respect to the direct link may be obtained from the UE.

The method may further include transmitting, to a controller of the LIS, an identifier of a reflected beam in the first scanning range, and transmitting, to the UE, an identifier of a receiving beam in the second scanning range, to perform beam scanning. For example, the transmission to the UE may be performed through PDCCH. The method may further include receiving, from the UE, an identifier of an optimal receiving beam for the reflective link determined by the UE through the beam scanning, and determining an optimal reflected beam of the LIS based on the identifier and information of the beam pair.

In an example, the first emitting beam direction at the base station side and the second emitting beam direction at the base station side each includes both a horizontal direction and a vertical direction, and the first scanning range and the second scanning range each includes both a horizontal scanning range and a vertical scanning range.

In a case of there being multiple LISs, the determination of the first scanning range and the second scanning range and the beam training of the reflective link between the LIS and the UE may be performed sequentially for each of the LISs. For example, a first scanning range and a second scanning range of a latter LIS may be further reduced by utilizing a determination result of a first scanning range and the second emitting beam direction at the base station side for a former LIS. For each LIS except a first one of the multiple LISs, the determination of the first scanning range and the second scanning range and the beam training of the reflective link between the LIS and the UE may be performed without a direct link.

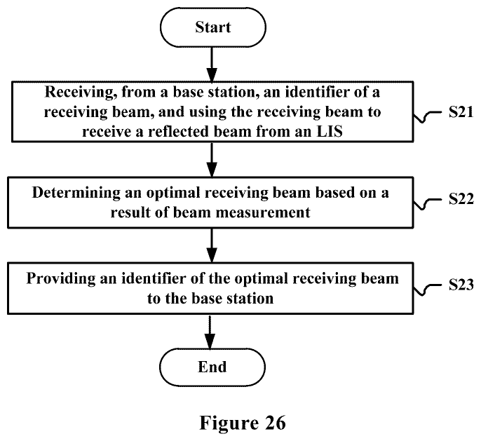

FIG. 26 shows a flowchart of a method for wireless communications according to another embodiment of the present disclosure. The method includes: receiving, from a base station, an identifier of each receiving beam within a particular scanning range, and using the receiving beam to receive a reflected beam from an LIS (S21), where the receiving beam and the reflected beam are determined by the base station as being in one-to-one correspondence; determining an optimal receiving beam based on a result of beam measurement (S22); and providing an identifier of the optimal receiving beam to the base station (S23). This method may be implemented at UE side, for example.

In addition, the method may further include determining an identifier of an optimal reflected beam from the LIS and providing the identifier of the optimal reflected beam to the base station.

Note that the above methods may be combined or used separately, details of which have been described in the first to fourth embodiments, and are not repeated here.

The technology of the present disclosure is applicable to various products.

The electronic apparatus 100 may be implemented as various types of base stations. The base stations may be implemented as any type of evolved node B (eNB) or gNB (5G base station). The eNB includes a macro eNB and a small eNB, for example. The small eNB may be an eNB such as a pico eNB, a micro eNB and a home (femto) eNB that covers a cell smaller than a macro cell. The situation is similar to the gNB. Alternatively, the base station may also be implemented as a base station of any other type, such as a NodeB and a base transceiver station (BTS). The base station may include a main body (that is also referred to as a base station device) configured to control wireless communications, and one or more remote radio heads (RRH) arranged in a different place from the main body. In addition, various types of user equipment each may operate as the base station by performing functions of the base station temporarily or semi-permanently.

The electronic apparatus 200 may be implemented as various types of user equipment. The user equipment may be implemented as a mobile terminal (such as a smartphone, a tablet personal computer (PC), a notebook PC, a portable game terminal, a portable/dongle type mobile router, and a digital camera), or an in-vehicle terminal (such as a car navigation apparatus). The user equipment may also be implemented as a terminal (that is also referred to as a machine type communication (MTC) terminal) that performs machine-to-machine (M2M) communication. Furthermore, the user equipment may be a wireless communication module (such as an integrated circuit module including a single die) mounted on each of the terminals.

### [Application Example of a Base Station]

### First Application Example

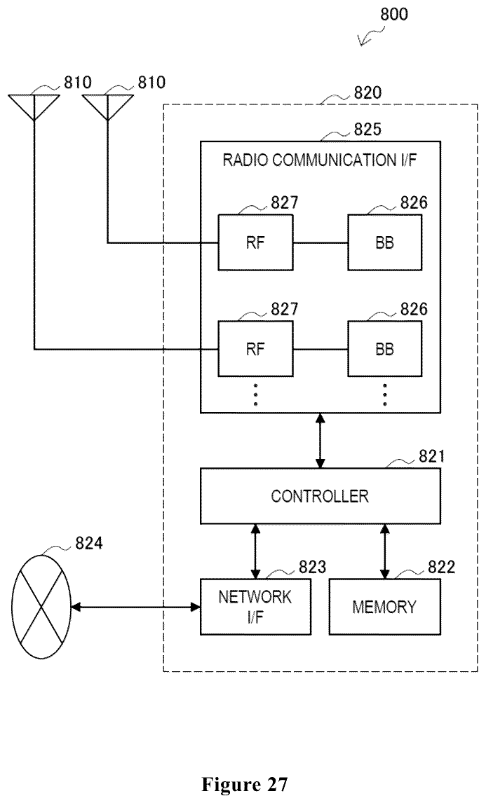

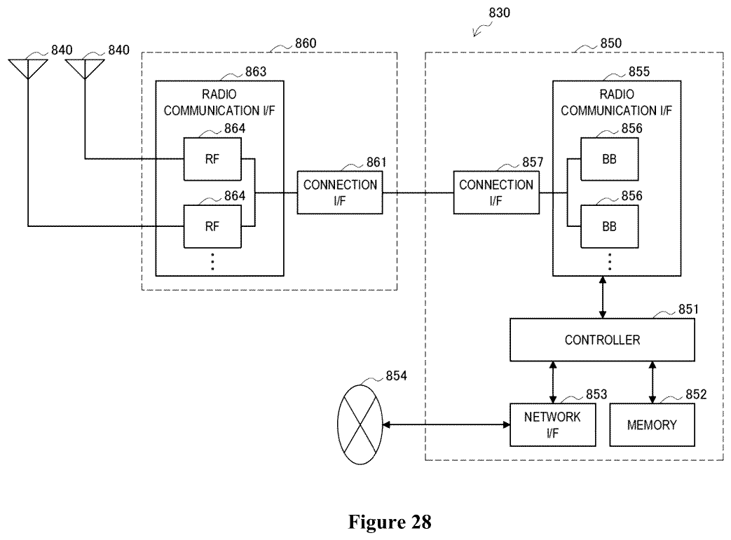

FIG. 27 is a block diagram illustrating a first example of an exemplary configuration of an eNB or gNB to which the technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via a radio frequency (RF) cable.

Each of the antennas 810 includes a single or multiple antennal elements (such as multiple antenna elements included in a multiple-input multiple-output (MIMO) antenna), and is used for the base station apparatus 820 to transmit and receive wireless signals. As illustrated in FIG. 27, the eNB 800 may include the multiple antennas 810. For example, the multiple antennas 810 may be compatible with multiple frequency bands used by the eNB 800. Although FIG. 27 illustrates the example in which the eNB 800 includes the multiple antennas 810, the eNB 800 may include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as a terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an SI interface and an X2 interface). The network interface 823 may also be a wired communication interface or a wireless communication interface for wireless backhaul. In a case that the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and perform various types of signal processing of layers (such as LI, Media Access Control (MAC), Radio Link Control (RLC), and a Packet Data Convergence Protocol (PDCP)). The BB processor 826 may have a part or all of the above-described logical functions, to replace the controller 821. The BB processor 826 may be a memory storing communication control programs, or a module including a processor and a related circuit configured to execute the programs. Updating the program may allow the functions of the BB processor 826 to be changed. The module may be a card or a blade inserted into a slot of the base station apparatus 820. Alternatively, the module may be a chip mounted on the card or the blade. Meanwhile, the RF circuit 827 may include, for example, a mixer, a filter, and an amplifier, and transmits and receives wireless signals via the antenna 810.

As illustrated in FIG. 27, the radio communication interface 825 may include multiple BB processors 826. For example, the multiple BB processors 826 may be compatible with multiple frequency bands used by the eNB 800. The radio communication interface 825 may include multiple RF circuits 827, as illustrated in FIG. 27. For example, the multiple RF circuits 827 may be compatible with multiple antenna elements. Although FIG. 27 illustrates the example in which the radio communication interface 825 includes multiple BB processors 826 and multiple RF circuits 827, the radio communication interface 825 may include a single BB processor 826 and a single RF circuit 827.

In the eNB 800 shown in FIG. 27, the communication unit 104 and the transceiver of the electronic apparatus 100 may be implemented by radio communication interface 825. At least part of the functions may also be implemented by the controller 821. For example, the controller 821 may reduce a beam scanning range of a reflective link between the LIS and the UE by utilizing a beam emitting direction of a base station relative to the UE and the LIS, by performing functions of the first determination unit 101, the second determination unit 102, the control unit 103 and the communication unit 104, thereby reducing the overload for beam training.

### Second Application Example

FIG. 28 is a block diagram illustrating a second example of an exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high speed line such as an optical fiber cable.

Each of the antennas 840 includes a single or multiple antennal elements (such as multiple antenna elements included in an MIMO antenna), and is used for the RRH 860 to transmit and receive wireless signals. As illustrated in FIG. 28, the eNB 830 may include multiple antennas 840. For example, the multiple antennas 840 may be compatible with multiple frequency bands used by the eNB 830. Although FIG. 28 illustrates the example in which the eNB 830 includes multiple antennas 840, the eNB 830 may include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 27.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 27, except that the BB processor 856 is connected to an RF circuit 864 of the RRH 860 via the connection interface 857. As illustrated in FIG. 28, the radio communication interface 855 may include multiple BB processors 856. For example, the multiple BB processors 856 may be compatible with multiple frequency bands used by the eNB 830. Although FIG. 28 illustrates the example in which the radio communication interface 855 includes multiple BB processors 856, the radio communication interface 855 may include a single BB processor 856.

The connection interface 857 is an interface for connecting the base station apparatus 850 (radio communication interface 855) to the RRH 860. The connection interface 857 may also be a communication module for communication in the above-described high speed line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high speed line.

The radio communication interface 863 transmits and receives wireless signals via the antenna 840. The radio communication interface 863 may typically include, for example, an RF circuit 864. The RF circuit 864 may include, for example, a mixer, a filter and an amplifier, and transmits and receives wireless signals via the antenna 840. The radio communication interface 863 may include multiple RF circuits 864, as illustrated in FIG. 28. For example, the multiple RF circuits 864 may support multiple antenna elements. Although FIG. 28 illustrates the example in which the radio communication interface 863 includes multiple RF circuits 864, the radio communication interface 863 may include a single RF circuit 864.

In the eNB 830 shown in FIG. 28, the communication unit 104 and the transceiver of the electronic apparatus 100 may be implemented by the radio communication interface 855 and/or the radio communication interface 863. At least part of the functions may also be implemented by the controller 851. For example, the controller 851 may reduce a beam scanning range of a reflective link between the LIS and the UE by utilizing a beam emitting direction of a base station relative to the UE and the LIS, by performing functions of the first determination unit 101, the second determination unit 102, the control unit 103 and the communication unit 104, thereby reducing the overload for beam training.

### [Application Examples of User Equipment]

### First Application Example

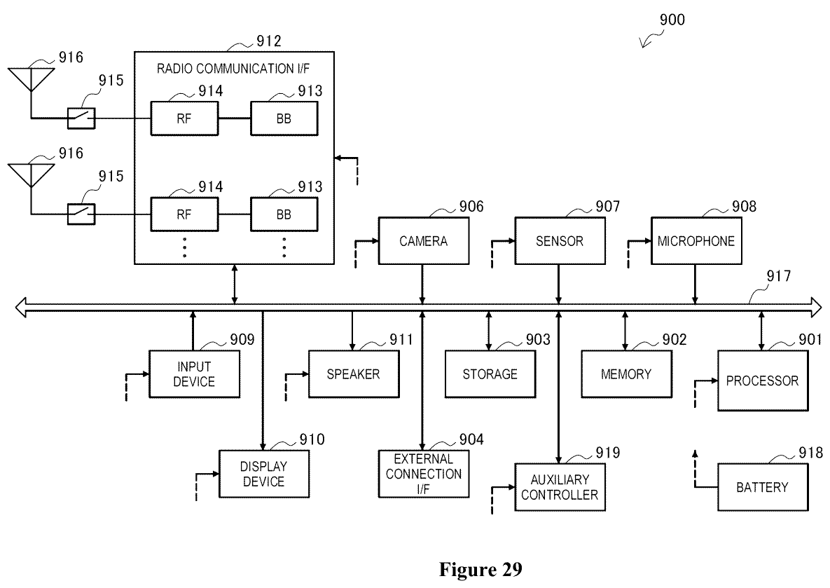

FIG. 29 is a block diagram illustrating an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals outputted from the smartphone 900 to sounds.

The radio communication interface 912 supports any cellular communication scheme (such as LTE and LTE-advanced), and performs wireless communications. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communication. The RF circuit 914 may include, for example, a mixer, a filter and an amplifier, and transmits and receives wireless signals via the antenna 916. It should be noted that although FIG. 29 illustrates a case that one RF link is connected to one antenna, which is only illustrative, and a situation where one RF link is connected to multiple antennas through multiple phase shifters is also possible. The radio communication interface 912 may be a chip module having the BB processor 913 and the RF circuit 914 integrated thereon. The radio communication interface 912 may include multiple BB processors 913 and multiple RF circuits 914, as illustrated in FIG. 29. Although FIG. 29 illustrates the example in which the radio communication interface 912 includes multiple BB processors 913 and multiple RF circuits 914, the radio communication interface 912 may include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a wireless local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include the multiple antennas 916, as illustrated in FIG. 29. Although FIG. 29 illustrates the example in which the smartphone 900 includes multiple antennas 916, the smartphone 900 may include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 29 via feeder lines, which are partially illustrated as dashed lines in FIG. 29. The auxiliary controller 919 operates a minimum necessary function of the smartphone 900, for example, in a sleep mode.

In the smartphone 900 shown in FIG. 29, the communication unit 201 and the transceiver of the electric apparatus 200 may be implemented by the radio communication interface 912. At least part of the functions may also be implemented by the processor 901 or the auxiliary controller 919. For example, the processor 901 or the auxiliary controller 919 may determine an optimal beam pair for a reflective link between the LIS and the UE by scanning beam pairs of one-to-one correspondence under the control of a base station, by implementing the functions of the communication unit 201 and the determination unit 202, reducing the overload for beam training.

### Second Application Example

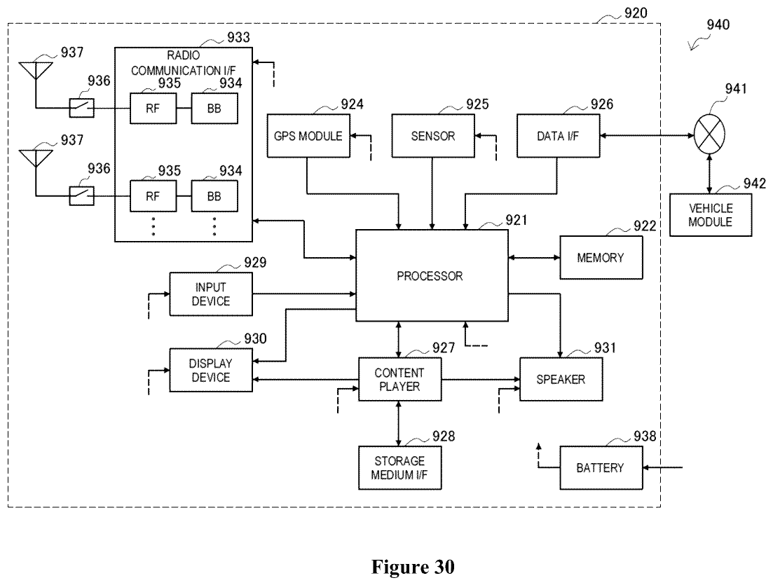

FIG. 30 is a block diagram illustrating an example of a schematic configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes RAM and ROM, and stores a program executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not illustrated, and acquires data (such as vehicle speed data) generated by the vehicle.

The content player 927 reproduces content stored in a storage medium (such as a CD and DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or reproduced content. The speaker 931 outputs a sound for the navigation function or the reproduced content.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communication. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as illustrated in FIG. 30. Although FIG. 30 illustrates the example in which the radio communication interface 933 includes multiple BB processors 934 and multiple RF circuits 935, the radio communication interface 933 may include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used for the radio communication interface 933 to transmit and receive wireless signals. As illustrated in FIG. 30, the car navigation apparatus 920 may include multiple antennas 937. Although FIG. 30 illustrates the example in which the car navigation apparatus 920 includes multiple antennas 937, the car navigation apparatus 920 may include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 illustrated in FIG. 30 via feeder lines that are partially illustrated as dash lines in FIG. 30. The battery 938 accumulates power supplied from the vehicle.

In the car navigation apparatus 920 shown in FIG. 30, the communication unit 201 and the transceiver of the electric apparatus 200 may be implemented by the radio communication interface 933. At least part of the functions may also be implemented by the processor 921. For example, the processor 921 may determine an optimal beam pair for a reflective link between the LIS and the UE by scanning beam pairs of one-to-one correspondence under the control of a base station, by implementing the functions of the communication unit 201 and the determination unit 202, reducing the overload for beam training.

The technology according to the present disclosure may also be implemented as an in-vehicle system (or a vehicle) 940 including one or more blocks of the car navigation device 920, the in-vehicle network 941, and a vehicle module 942. The vehicle module 942 generates vehicle data (such as vehicle speed, engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

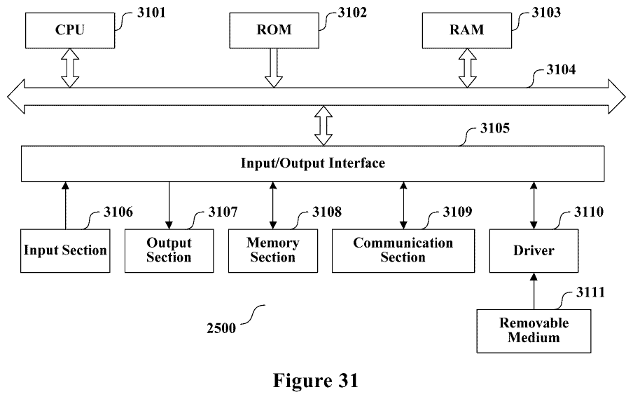

In the case where the present disclosure is realized with software or firmware, a program constituting the software is installed in a computer with a dedicated hardware structure (e.g. the general computer 3100 shown in FIG. 31) from a storage medium or network, wherein the computer is capable of implementing various functions when installed with various programs.

In FIG. 31, a central processing unit (CPU) 3101 executes various processing according to a program stored in a read-only memory (ROM) 3102 or a program loaded to a random access memory (RAM) 3103 from a memory section 3108. The data needed for the various processing of the CPU 3101 may be stored in the RAM 3103 as needed. The CPU 3101, the ROM 3102 and the RAM 3103 are linked with each other via a bus 3104. An input/output interface 3105 is also linked to the bus 3104.

The following components are linked to the input/output interface 3105: an input section 3106 (including keyboard, mouse and the like), an output section 3107 (including displays such as a cathode ray tube (CRT), a liquid crystal display (LCD), a loudspeaker and the like), a memory section 3108 (including hard disc and the like), and a communication section 3109 (including a network interface card such as a LAN card, modem and the like). The communication section 3109 performs communication processing via a network such as the Internet. A driver 3110 may also be linked to the input/output interface 3105, if needed. If needed, a removable medium 3111, for example, a magnetic disc, an optical disc, a magnetic optical disc, a semiconductor memory and the like, may be installed in the driver 3110, so that the computer program read therefrom is installed in the memory section 3108 as appropriate.

In the case where the foregoing series of processing is achieved through software, programs forming the software are installed from a network such as the Internet or a memory medium such as the removable medium 3111.

It should be appreciated by those skilled in the art that the memory medium is not limited to the removable medium 3111 shown in FIG. 31, which has program stored therein and is distributed separately from the apparatus so as to provide the programs to users. The removable medium 3111 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 3102 and the memory section 3108 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
processing circuitry, configured to:
determine a first emitting beam direction at a base station side of a direct link of the base station with respect to user equipment (UE), and a second emitting beam direction at the base station side of a reflective link of the base station with respect to a large intelligent surface (LIS);
determine, based on the first emitting beam direction at the base station side and the second emitting beam direction at the base station side, a first scanning range of a reflected beam of a reflective link of the LIS with respect to the UE and a second scanning range of a receiving beam of the UE; and
perform control to perform beam training of the reflective link between the LIS and the UE based on the first scanning range and the second scanning range.

2. The electronic apparatus according to claim 1, wherein the processing circuitry is configured to determine the first emitting beam direction at the base station side by performing beam training on the direct link.

3. The electronic apparatus according to claim 2, wherein the processing circuitry is configured to determine the first emitting beam direction at the base station side by adopting hierarchical beam training based on a hierarchical codebook.

4. The electronic apparatus according to claim 1, wherein the processing circuitry is configured to determine the second emitting beam direction at the base station side by adopting one of the following manners: performing beam training on the reflective link between the base station and the LIS: determining based on a geometrical location relationship between the base station and the LIS.

5. The electronic apparatus according to claim 4, wherein the performing beam training on the reflective link between the base station and the LIS comprises adopting hierarchical beam training which is based on a hierarchical codebook, and/or
wherein the processing circuitry is configured to perform beam training of the reflective link between the LIS and the UE by adopting hierarchical beam training based on a hierarchical codebook.

6. The electronic apparatus according to claim 4, wherein the processing circuitry is configured to, in a case of determining the second emitting beam direction at the base station side by performing beam training on the reflective link between the base station and the LIS, determine the second emitting beam direction at the base station side based on a serial number of a time slot corresponding to a maximum receiving power of the base station.

7. The electronic apparatus according to claim 1, wherein the processing circuitry is configured to determine the first scanning range and the second scanning range based on the first emitting beam direction at the base station side and the second emitting beam direction at the base station side, according to a geometrical location relationship among the base station, the LIS and the UE.

8. The electronic apparatus according to claim 7, wherein the first emitting beam direction at the base station side and the second emitting beam direction at the base station side are represented by beam identifiers respectively, and the first scanning range and the second scanning range comprise identifiers of to-be-scanned beams respectively, and/or
wherein the first scanning range and the second scanning range each has an angle range as follows: a sum of a first angle of departure corresponding to the first emitting beam direction at the base station side and a second angle of departure corresponding to the second emitting beam direction at the base station side.

9. (canceled)

10. The electronic apparatus according to claim 1, wherein the processing circuitry is configured to match a beam within the first scanning range and a beam within the second scanning range as a beam pair in one-to-one correspondence, and control the LIS and the UE to perform beam scanning based on the beam pair,
wherein the processing circuitry is further configured to receive, from the UE, an identifier of an optimal receiving beam for the reflective link determined by the UE through the beam scanning, and determine an optimal reflected beam of the LIS based on the identifier and information of the beam pair.

11. (canceled)

12. The electronic apparatus according to claim 1, wherein the first emitting beam direction at the base station side and the second emitting beam direction at the base station side each comprises both a horizontal direction and a vertical direction, and the first scanning range and the second scanning range each comprises both a horizontal scanning range and a vertical scanning range.

13. The electronic apparatus according to claim 1, wherein in a case that there are multiple LISs, the processing circuitry is configured to perform sequentially, for each LIS, determination of the first scanning range and the second scanning range and beam training of the reflective link between the LIS and the UE.

14. The electronic apparatus according to claim 13, wherein the processing circuitry is further configured to further reduce a first scanning range and a second scanning range of a latter LIS by utilizing a determination result of a first scanning range and the second emitting beam direction at the base station side for a former LIS,
wherein for each of remaining LISs except a first LIS of the multiple LISs, the processing circuitry is configured to perform determination of the first scanning range and the second scanning range and beam training of the reflective link between the LIS and the UE without a direct link.

15. (canceled)

16. The electronic apparatus according to claim 1, wherein the processing circuitry is further configured to transmit, to the LIS, a signaling indicating an LIS operating mode which comprises OFF and ON.

17. The electronic apparatus according to claim 16, wherein the processing circuitry is configured to transmit a signaling indicating OFF to the LIS for determining the first emitting beam direction at the base station side, and transmit a signaling indicating ON to the LIS for determining the second emitting beam direction at the base station side and performing beam training of the reflective link between the LIS and the UE.

18. The electronic apparatus according to claim 2, wherein the processing circuitry is further configured to obtain, from the UE, an identifier of an optimal emitting beam of the base station with respect to the direct link, and determine the first emitting beam direction at the base station side based on the optimal emitting beam of the base station.

19. The electronic apparatus according to claim 18, wherein the processing circuitry is further configured to obtain, from the UE, an identifier of an optimal receiving beam of the UE with respect to the direct link.

20. The electronic apparatus according to claim 1, wherein the processing circuitry is configured to transmit, to a controller of the LIS, an identifier of a reflected beam in the first scanning range, and transmit, to the UE, an identifier of a receiving beam in the second scanning range, to perform beam scanning,
wherein the processing circuitry is configured to perform the transmitting to the UE through a physical downlink control channel.

21.-22. (canceled)

23. An electronic apparatus for wireless communications, comprising:
processing circuitry, configured to:
receive, from a base station, an identifier of each receiving beam within a particular scanning range, and use the receiving beam to receive a reflected beam from a large intelligent surface (LIS), wherein the receiving beam and the reflected beam are determined by the base station as being in one-to-one correspondence;
determine an optimal receiving beam based on a result of beam measurement; and
provide an identifier of the optimal receiving beam to the base station.

24. The electronic apparatus according to claim 23, wherein the processing circuitry is further configured to determine an identifier of an optimal reflected beam from the LIS, and provide the identifier of the optimal reflected beam to the base station.

25. A method for wireless communications, comprising:
determining a first emitting beam direction at a base station side of a direct link of the base station with respect to user equipment (UE), and a second emitting beam direction at the base station side of a reflective link of the base station with respect to a large intelligent surface (LIS);
determining, based on the first emitting beam direction at the base station side and the second emitting beam direction at the base station side, a first scanning range of a reflected beam of a reflective link of the LIS with respect to the UE and a second scanning range of a receiving beam of the UE; and
performing control to perform beam training of the reflective link between the LIS and the UE based on the first scanning range and the second scanning range.

26.-27. (canceled)
